(19) United States
(12) Patent Application Publication
(10) Pub. No.: US 2008/0047945 A1
(43) Pub. Date: Feb. 28, 2008

(54) Method and apparatus for a heated comforter

(75) Inventor: Po Chu Yip, Hong Kong (HK)

Correspondence Address: DARBY & DARBY P.C., P.O. BOX 770, Church Street Station, New York, NY, 10008-0770, US

(73) Assignee: Pac-Fung Feather Company Limited, Kowloon (HK)

(21) Appl. No.: 11/501,487

(22) Filed: Aug. 8, 2006

(51) Int. Cl. H05B 3/00

(52) U.S. Cl. 219/212

(57) ABSTRACT

An electrically heatable comforter is formed from upper and lower fabric outer layers extending generally parallel to each other and being closed along the edges of the layers to form a shell. One or more interior panels extend between the outer layers, and have respective ends connected to, the upper and lower outer layers. The comforter further includes a sleeve that is fixed to the interior panels and is spaced from their connections to the upper and lower layer. A heating wire is located within at least a portion of the sleeve in order to hold the heating wire away from the outer surfaces of the comforter and to keep the wire from moving about. In addition, the comforter can be stuffed with a fill material located inside the comforter shell on at least one side of the interior panels.

### FIELD OF INVENTION

The present invention relates to a comforter, and in particular, to a heated comforter that protects a user from risks associated with using a traditional electric blanket.

### BACKGROUND OF THE INVENTION

Traditional heating blankets typically consist of a fabric enclosure in which an electrical heating wire is inserted. In traditional heating blankets, the electrical heating wire is fully contained within the blanket. U.S. Pat. Nos. 2,706,768; 2,708,235; and 3,064,332, all to Kaplan, discloses various wiring diagrams and methods for stitching an electric blanket so that the heating wires are contained within the blanket. However, in these blankets, the heating wire is stitched directly to at least one outer layer of the sheet or blanket. This may result in the overheating of the layer and/or the heating wire, which is a dangerous risk for the user.

Additionally, in U.S. Pat. No. 6,753,514 to Harashima, the heater wire is arranged along the base cloth and is sandwiched within a mat body to form an electric blanket. However, in this arrangement, the heater wire is allowed to move about within the blanket, which can cause the heating wire to prematurely rip or tear from the enclosing sleeve, as well as the overheating of an outer layer of the blanket with which it comes into contact.

### SUMMARY OF THE INVENTION

The present invention relates to a comforter which can provide adequate warmth to a user while reducing the risks of overheating and tearing associated with using a traditional electrically-powered blanket.

In an exemplary embodiment, the present invention provides a unique method of affixing the heating wire to the interior of the comforter to ensure that the heating wire does not move around and contact or tear an outer layer of the comforter while it is in use. By fixing the heating wire in place in the interior of the comforter to prevent the heating wire from moving around, the lifespan of the heating wire, as well as the outer layer of the comforter, are increased.

In addition, an added benefit of an exemplary embodiment of the present invention is a reduction in the risk of electrocution of the user of the heated comforter. This can be achieved by combining the heating wire with sufficient stuffing material within the comforter so that the amount of electricity required to power the comforter is reduced. Additionally, the heating wire can be fixed in place by using a cloth sleeve to surround it, and by fastening the sleeve to an interior panel of the comforter. This provides an extra safety measure to the user.

### BRIEF DESCRIPTION OF THE DRAWINGS

Exemplary embodiments of the present inventions are explained in more detail below with reference to the accompanying drawings, which show:

FIG. 1 is a perspective view of a heating wire according to the present invention;

FIG. 2 is a cross-sectional view of the heated comforter according to the present invention;

FIG. 3A is a first embodiment of a sleeve of the heated comforter according to the present invention;

FIG. 3B is a second embodiment of a sleeve of the heated comforter according to the present invention;

FIG. 3C is a third embodiment of a sleeve of the heated comforter according to the present invention;

FIG. 4A is a front view of a first embodiment for attaching the heating wire to the comforter according to the present invention;

FIG. 4B is a front view of a second embodiment for attaching the heating wire to the comforter according to the present invention;

FIG. 5A is a first schematic diagram of the wiring pattern of a heated comforter according to the present invention;

FIG. 5B is a second schematic diagram of the wiring pattern of a heated comforter according to the present invention; and

FIG. 6 is a partial top view of the heated comforter according to the present invention.

### DETAILED DESCRIPTION OF THE INVENTION

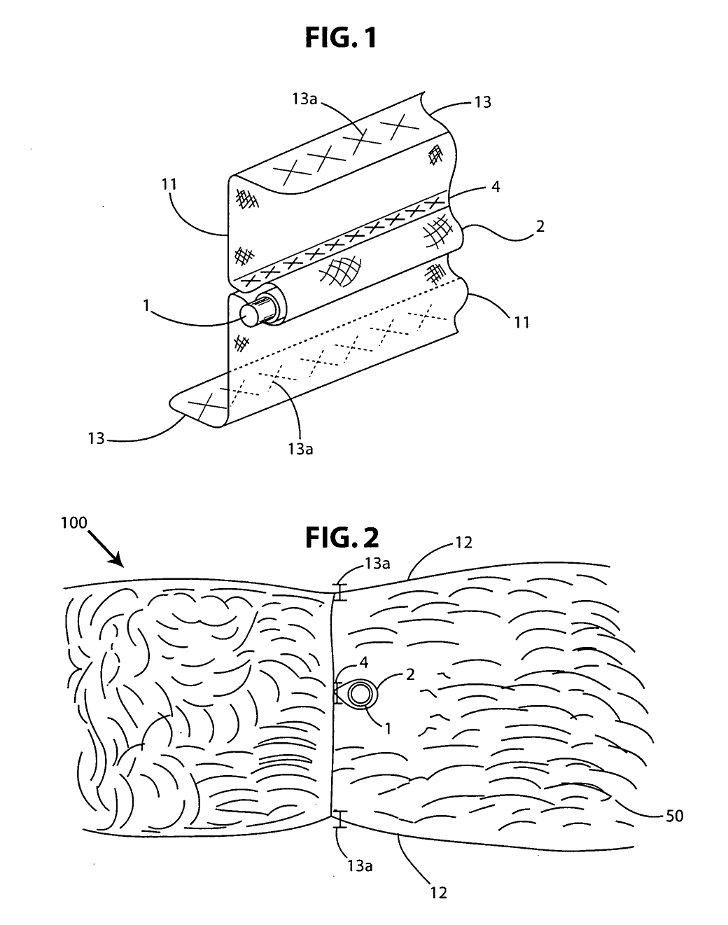

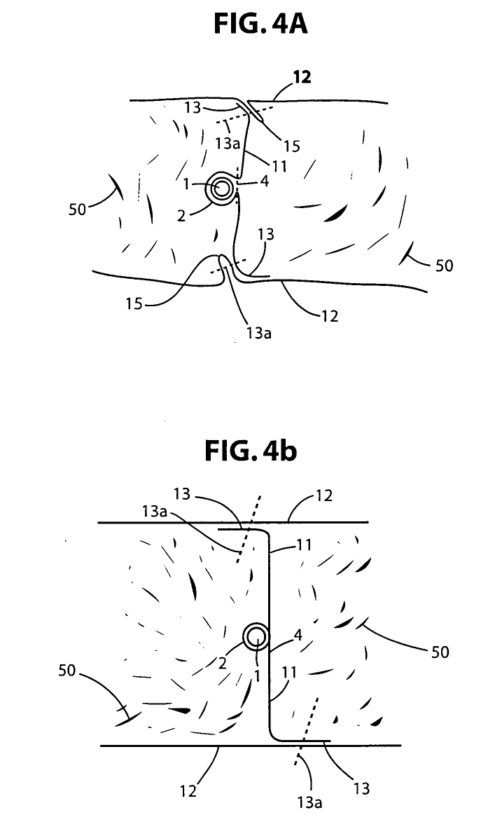

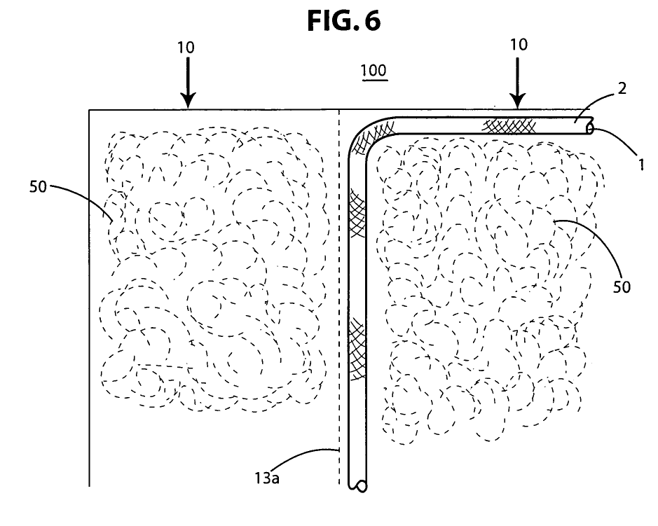

As shown in FIGS. 1, 4 and 5, which illustrates an exemplary embodiment of the present invention, a comforter 100 comprises upper and lower layers 12 of fabric that extend generally parallel to each other. A fill material 50 is located between the layers 12. The material 50 can be down, feathers, polyester, or a combination of materials so that the comforter 100 provides more warmth than ordinary blankets. The layers 12 are sewn together about their periphery to form a shell. Further, a plurality of interior panels 11 are spaced throughout the shell and extend through the interior of the comforter so as to connect the upper and lower layers 12, e.g., by stitches 13a along the entire length of tab 13 (see FIG. 4A). Thus, the interior panels essentially divide the comforter up into segments 10, as illustrated in FIG. 6.

According to the present invention, a heating wire 1 is provided within the shell of the comforter and it attached to at least one interior panel 11. One way of making the attachment is to sew together a portion of the interior panel 11 with stitching 4 to form a sleeve 2. The interior panel 11 is ideally a cloth-like material, but can be other textiles or other materials that are sufficiently flexible.

As illustrated in FIGS. 2 and 4, by enclosing the heating wire 1 in the sleeve 2, the heating wire I is fixed in place within the interior of the comforter 100, i.e., between the upper and lower outer layers 12 of the comforter 100. While the heating wire 1 is shown entirely within the sleeve 2, it is within the scope of the invention to have the sleeve 2 in segments which support the wire 1 at spaced locations.

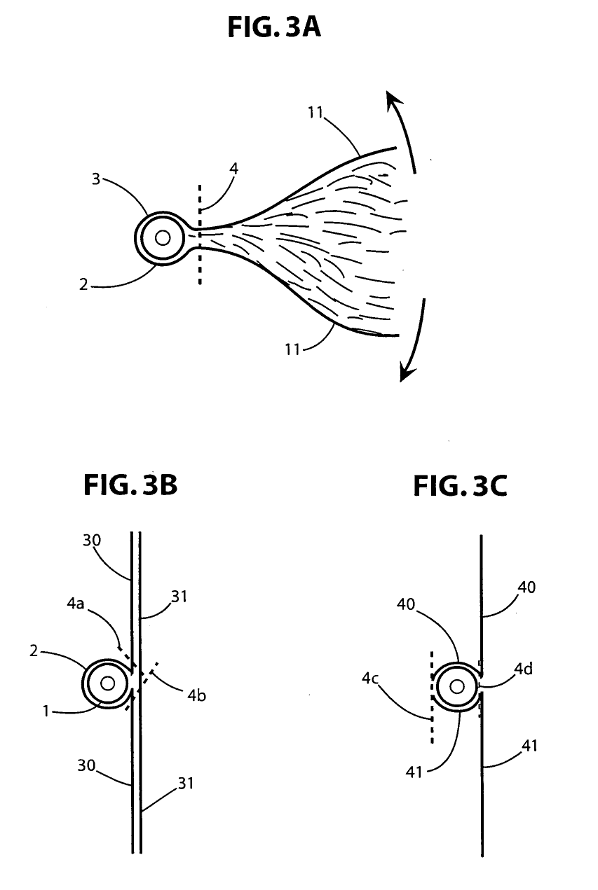

In one embodiment of the present invention, the sleeve 2 and the interior panel 11 are made from a single piece of cloth 3 that is folded over to form the sleeve 2 that encloses the heating wire 1, as illustrated in FIG. 3A. In this particular embodiment, only one set of stitching 4 is required to enclose the heating wire 1. The cloth 3 is stitched sufficiently close enough to the heating wire 1 such that the heating wire I cannot slip or move around in the sleeve 2. The stitching 4 may also be positioned such that the heating wire I cannot be easily pulled out of the sleeve 2. Having the heating wire 1 fixed in place prevents the heating wire 1 from being susceptible to excessive wear and tear, thereby prolonging the life of the heating wire 1, and likewise the comforter 100. This also keeps the heating wire 1 away from the layers 12 that come into contact with a user's body, which prevents the user's body from becoming uncomfortably warm. Having the heating wire 1 fixed in place also prevents the wire 1 from wearing a hole in the outer layers 12 of the comforter 100, thus exposing the wire 1. Further, by keeping the wire 1 buried in the material 50, the comforter 100 can produce sufficient heat without becoming overheated.

As illustrated in FIG. 3A, the ends of the interior panel 11 “open” in opposite directions and are attached to the respective outer layers 12 of the comforter 100. FIGS. 4a and 4b illustrate examples of how the interior panel 11 may be attached to the outer layers 12 of the comforter 100. As shown in FIG. 4A, a portion of the interior panel 11 can be stitched to a respective folded portion 15 of the respective outer layer 12 of the comforter 100 via stitching 13a through tab 13. In this embodiment, the stitching 13a is hidden on the inside of the comforter 100, and is not visible from the outside.

Alternatively, as illustrated in FIG. 4B, a portion of the interior panel 11 can be stitched directly to the respective outer layer 12 of the comforter 100 via stitching 13a along tab 13. In this embodiment, the stitching 13a is visible from the outside of the comforter 100.

In a second embodiment of the present invention, the sleeve 2 is made from a first cloth 30 and a second cloth 31 which are located next to each other and are stitched together via stitches 4a, 4b to enclose the heating wire 1, as illustrated in FIG. 3B. In this embodiment, two sets of stitching 4a, 4b, are required to enclose the heating wire 1 in such a way that it is difficult for the heating wire 1 to move or slip around in the sleeve 2. As with the previous embodiment, the stitching 4a, 4b should be positioned such that the heating wire 1 cannot be easily pulled out of the sleeve 2. The respective ends of the first cloth 30 and second cloth 31 are stitched to the respective outer layers 12 of the comforter 100 in a manner similar to the one illustrated in FIGS. 4A-4B and described above.

In a third embodiment of the present invention, the sleeve 2 is made from a first cloth 40 and a second cloth 41 which are placed end-to-end and then stitched together via stitches 4c, 4d to enclose the heating wire 1, as illustrated in FIG. 3C. In this embodiment, two sets of stitching 4c, 4d, are required to enclose the heating wire 1 in such a way that it is difficult for the heating wire 1 to move or slip around in the sleeve 2. The stitching 4c is located on one side of the heating wire 1, while the stitching 4d is positioned directly opposite, as illustrated in FIG. 3C. As with the previous embodiment, the stitching 4c, 4d should be positioned such that the heating wire 1 cannot be easily pulled out of the sleeve 2. The outer ends of the respective first cloth 40 and second cloth 41 are stitched to the respective outer layers 12 of the comforter 100 in a manner similar to the one illustrated in FIGS. 4A-4B and described above.

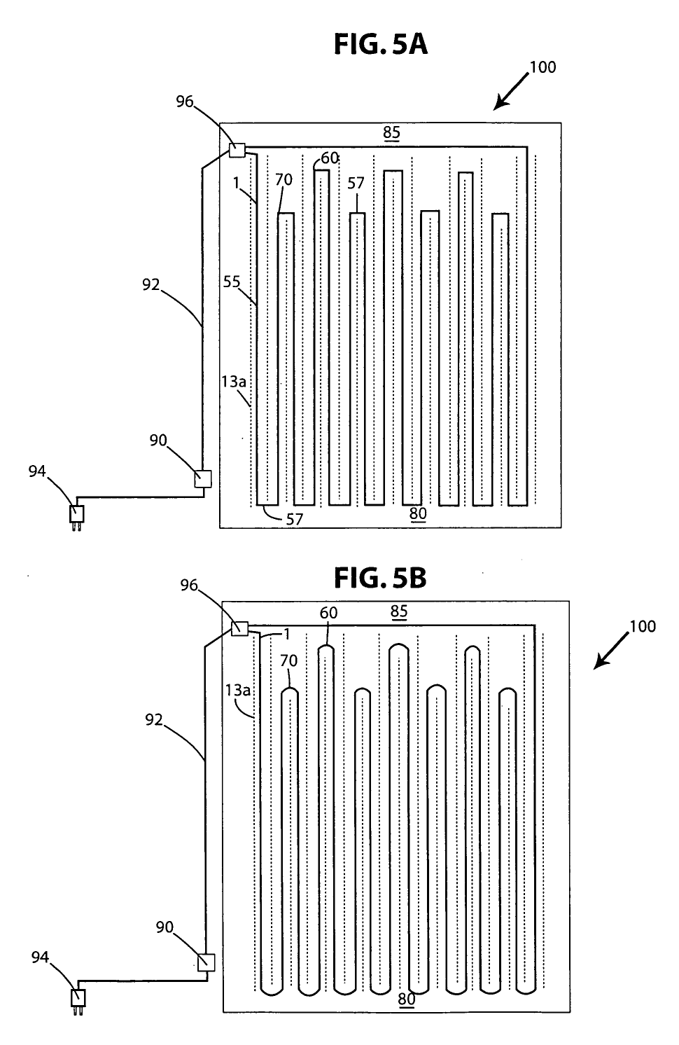

FIG. 5A illustrates a preferred layout for the heating wire 1 of the present invention. The heating wire 1 is arranged in a rectangular pattern with longitudinal runs 55 of heating wire 1 and lateral runs 57. At one side of the wiring layout (referred to hereinafter as “the bottom edge 80”), the position of the lateral runs 57 of the heating wire 1 are flush with each other near the bottom edge 80 of the comforter. At the opposing side of the wiring layout (referred to hereinafter as “the top edge 85”), the lateral runs 57 of the heating wire 1 alternate between a shorter wire length, as illustrated at point 70, and a longer wire length, illustrated at point 60. It is to be understood that the terms “top” and “bottom” are merely for orientation purposes and are not limiting.

The stitching 13a of the interior panels also alternates in accordance with the varying wire length. If the heating wire 1 does not have a lateral run 57 in its path, then the stitching 13a on tab 13 extends from the bottom side through the entire length of the comforter 100. If there is a lateral run 57 at the end of the shorter wire length, as is at point 70, the stitching 13a of tab 13 extends from the bottom edge 80 along the shorter wire length, stopping before the lateral run 57 itself. Likewise, if a lateral run 57 is located at the end of the longer wire length, i.e., at point 60, the stitching 13a on tab 13 extends from the bottom edge 80 along the length of the longer wire run, stopping before the lateral run 57 itself. Thus, the stitching pattern varies in accordance with the alternating heating wire length.

It can be seen that the density of heating wire runs is greater at the bottom edge 80 of the comforter 100 than at the top edge 85, due to the short runs at the top edge 85. As a result, there will be more heat towards the bottom edge 80 than towards the top edge 85. Thus, if the user orients the comforter 100 so that the bottom edge 80 is at his feet, the comforter 100 will keep his feet warmer than his upper body.

It is to be understood that the wiring layout of the present invention need not be in the alternating fashion as described above. Other arrangements are also possible, such as an even distribution where the lateral runs 57 are flush with one another at each respective edges 80, 85 of the comforter 100, resulting in a uniform heating pattern. In addition, the wiring pattern need not have straight lateral runs. Any construction which allows the heating wire to extend in an opposite direction, such as a curved or slanted junction portion, would suffice. FIG. 5B illustrates a heating wire layout having curved junction portions 60, 70.

In addition, the heating wire pattern, for example, may have long lateral runs and short longitudinal ones. Also, the heating wire spacing may be greater toward the middle of the comforter and wider toward the sides so that most of the heat is in the middle of the comforter 100. Since the sides of the comforter 100 typically hang off the sides of the bed, this may avoid wasteful heating on the side of the bed. Alternatively, the heating wire pattern may be denser toward the sides than in the middle so that the edges where the comforter is lifted when the user gets in and out of bed may be provided with more heat. In essence, any pattern of heating wire can be provided to achieve a desired heating pattern.

As illustrated in FIG. 6, the heating wire 1 is located within the comforter 100, and is secured to the outer layers 12 of the internal panels 11 of the comforter 100 via stitching 13a along tab 13. Note that the panels 11 extend not only longitudinally to support the long runs of heating wire, but also laterally to support the shorter lateral runs. The comforter 100 is also filled with the stuffing material 50 to provide extra warmth.

Optionally, the comforter 100 can operate at an extra-low voltage of 48 volts or lower. Since the comforter 100 can be stuffed with stuffing 50, the warmth provided by the heated comforter 100 via the heating wire 1 can be reduced. This can be accomplished by reducing the voltage supplied to the heating wire 1. A voltage control 90 is connected in a power line 92 extending from an electrical plug 94 to a terminal 96 on the comforter. Having the comforter 100 operate at a low voltage provides a reduced risk of electrocution of the user. Other risks associated with the overheating of traditional electrical blankets, such as fire, are also reduced.

According to the embodiments of the present invention, by placing the heating wire 1, located within the sleeve 2, within the comforter 100 along with the stuffing material 50, the comforter I 00 prevents a user from having direct contact with the heating wire 1, as illustrated in FIG. 2. This prevents the user from burning him or herself, since the user will not come into contact with a hot heating wire.

Another benefit of having the heating wire 1 fixed in place is that the heating wire 1 is no longer subjected to excessive wear and tear, thereby prolonging the life of the heating wire 1, and likewise the comforter 100.

While the invention has been particularly shown and described with reference to preferred embodiments thereof, it will be understood by those skilled in the art that various changes in form and details may be made therein without departing from the spirit and scope of the invention.

I claim:

1. An electrically heatable comforter comprising:
upper and lower outer layers of fabric extending generally parallel to each other and being closed along the edges of the layers to form a shell;
at least one interior panel extending between, and having respective ends connected to, the upper and lower layers;
a sleeve fixed to said at least one interior panel and spaced from its connections to the upper and lower layer; and
a heating wire located within at least a portion of said sleeve.

2. The comforter of claim 1, further including fill material located in the shell and on at least one side of the interior panel.

3. The comforter of claim 2 wherein the fill material is one of down, feathers, polyester, or a combination of materials.

4. The comforter of claim 1 wherein the interior panel is made of a flexible fabric material.

5. The comforter of claim 1 wherein the sleeve in made from a folded and stitched portion of the interior panel.

6. The comforter of claim 1 wherein the sleeve is made from a separate piece of flexible fabric folded about the heating wire and stitched to the interior panel.

7. The comforter of claim 1 wherein the interior panel and sleeve are made from two pieces of flexible fabric placed end-to-end, with the ends in proximity to each other partially surrounding the wire, and being stitched together.

8. The comforter of claim 1, further comprising:
a power cord connected at one end to a pattern of heating wires in the comforter by a terminal;
an electrical plug at the other end of the power cord; and
a voltage controller in the power cord for reducing the voltage applied to the heating wires from that available at the electrical plug.

9. The comforter of claim 8 wherein the voltage controller reduces the voltage applied to the terminal to about 48 volts.

10. The comforter of claim 2, further comprising:
a power cord connected at one end to a pattern of heating wires in the comforter by a terminal;
an electrical plug at the other end of the power cord; and
a voltage controller in the power cord for reducing the voltage applied to the heating wires from that available at the electrical plug.
